(19) United States
(12) Patent Application Publication
(10) Pub. No.: US 2013/0173370 A1
(43) Pub. Date: Jul. 4, 2013

(54) SYSTEMS AND METHODS FOR PROVIDING INFORMATION TO CONSUMERS

(71) Applicants: Guy Schory, San Francisco, CA (US); Robert Dean Veres, Los Gatos, CA (US); Ares Sakamoto, Lexington, TX (US); Westley Martin Stringfellow, Los Gatos, CA (US); Joel Yarbrough, Oakland, CA (US)

(72) Inventors: Guy Schory, San Francisco, CA (US); Robert Dean Veres, Los Gatos, CA (US); Ares Sakamoto, Lexington, TX (US); Westley Martin Stringfellow, Los Gatos, CA (US); Joel Yarbrough, Oakland, CA (US)

(73) Assignee: EBAY INC., SAN JOSE, CA (US)

(21) Appl. No.: 13/341,335

(22) Filed: Dec. 30, 2011

(51) Int. Cl. G06Q 30/02

(52) U.S. Cl. 705/14.19; 705/14.49; 705/14.53; 705/14.66; 705/14.1

(57) ABSTRACT

A method and a system to provide information to consumers are provided. A code identification module may receive one or more scanned machine-readable codes. The code identification may further identify respective descriptions of the items corresponding to the one or more scanned machine-readable codes. An incentive generation module may provide to a user an incentive interface depicting a first description of a first set of incentives available with the purchase of a first item corresponding to a first scanned machine-readable code and second description of a second set of incentives available with the purchase of a second item corresponding to a second scanned machine-readable code.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2011, All Rights Reserved.

### TECHNICAL FIELD

The present application relates generally to the technical field of network communications and, in one specific example, to systems and methods for providing information to consumers.

### BACKGROUND

While shopping, consumers may rely on in-store signage or handwritten lists to select items for purchase. However, a consumer may still need to select an item from a range of available items on the store shelves. This decision is typically made by the consumer on-the-fly and with limited information.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram of an example information system, according to various embodiments.

FIG. 3 is a flowchart illustrating an example method of providing information, according to various embodiments.

FIG. 4 is a high-level entity-relationship diagram, illustrating various tables that may be maintained within the databases, and that are utilized by and support the example information system.

FIGS. 5-8 depict example user interfaces that may be presented to the user, according to an example embodiment.

FIG. 9 is a diagrammatic representation of machine in the example form of a computer system within which a set of instructions, for causing the machine to perform any one or more of the methodologies discussed herein, may be executed.

### DETAILED DESCRIPTION

Example methods and systems to provide information to consumers are described. In the following description, for purposes of explanation, numerous specific details are set forth in order to provide a thorough understanding of example embodiments. It will be evident, however, to one skilled in the art that the present invention may be practiced without these specific details.

When a consumer visits a brick-and-mortar store, the user may have a general idea of which products the user wants to purchase. For example, the user may carry a shopping list that the user has written listing the products the consumer wishes to purchase. The consumer, while shopping, may identify a sought-after product but be faced with a selection of a number of items of the product to purchase. For example, a user looking to purchase a pen (e.g., product) may visit a store that has dozens of different pen brands and styles (e.g., item) for sale. The user may be able to quickly reduce the selection to five or fewer items but may be unable to further decide which pen to purchase. The user may ultimately buy all five pens or may randomly choose one of the five remaining pens.

Systems and methods described herein provide additional information to the consumer about a selection of items. The consumer may, using a smart phone, scan the barcodes of one or more items to look up additional information about those items. The smart phone may provide a display to the user that compares attributes of the items. Further, the systems and methods may include displaying reviews or recommendations for the items from, for example, the user's social network. Further, a number of incentives provided by the merchant or another entity may be displayed to the user. In some instances, the incentives may be personalized to the user. Moreover, the systems and methods described herein include advertisements to be targeted to a smart phone based on the barcode scanned.

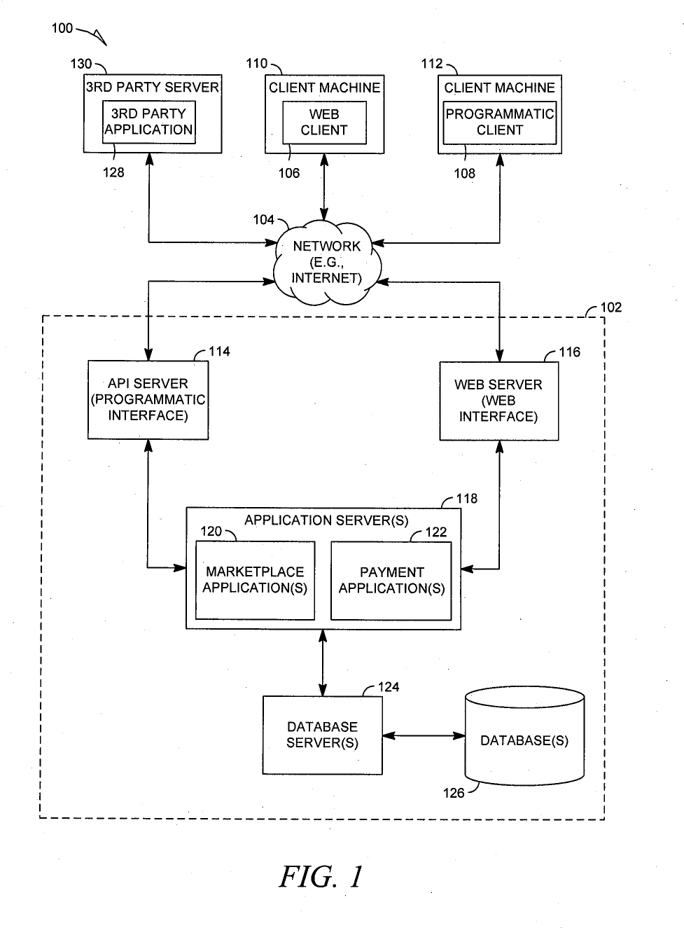

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

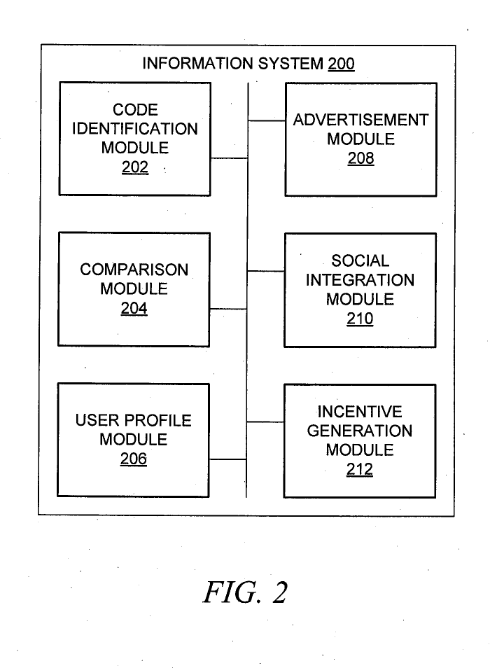

FIG. 2 is a block diagram of an example information system 200, according to various embodiments. The example information system 200 may be part of the marketplace applications 120. In some instances, the information system 200 is implemented, in whole or in part, on a client machine (e.g., client machines 110 and 112). The information systems 200 may comprise one or more hardware or software modules.

In an example embodiment, a code identification module 202 is configured to receive a scanned machine-readable code and identify a description of the item that corresponds to the machine-readable code. The machine-readable code may be a Universal Product Code (UPC), an International Standard Book Number (ISBN), a Stock Keeping Unit (SKU) code, a Quick Response (QR) code, or another machine-readable code that is printed on the item or the packaging of the item or attached to the item or the packaging of the item. The machine-readable code may be scanned using a machine-readable code reader or may be read from an image of the machine-readable code captured using, for example, a camera within the client machine (e.g., client machine 110). The machine-readable code may be read to decode a series of alphanumeric characters encoded by the machine-readable code.

Upon decoding the series of alphanumeric characters encoded by the machine-readable code, the code identification module 202 is configured to identify a description of an item corresponding to the series of alphanumeric characters. The item description may include information about the item in the form of text, images, audio recordings, or video recordings. The information may be unstructured or structured. The information may include attribute-value pairs that associate values to specific characteristics of the item.

The code identification module 202 may send the information or a display of the information to the client machine for display to a user in a graphical user interface (GUI). The GUI may be generated at the client machine or by the code identification module 202. The GUI may include all or a portion of the information about the item.

In some instances, the code identification module 202 may store machine-readable codes previously scanned by the user. The user, upon scanning a machine-readable code, may be provided an option to save the machine-readable code or series of alphanumeric characters corresponding to the machine-readable code. Sometime later, the user may be provided an interface from which the user may select the machine-readable code. Upon selection of the machine-readable code, the information system 200 may treat the machine-readable code as being scanned by the user and provide information corresponding to the machine-readable code as described herein.

A comparison module 204 is configured to generate an item comparison GUI based on two or more scanned barcodes. The user may scan or capture the machine-readable codes using the client device and provide an indication to compare the items associated with the machine-readable codes. The comparison module 204 may access the information about the items corresponding to the respective machine-readable codes and generate an item comparison interface.

The item comparison interface includes information about items for each machine-readable code scanned by the user or selected by the user from machine-readable codes previously scanned by the user. The machine-readable codes of the items to be compared may be scanned in a “compare item” mode where the user first indicates that an item comparison interface is desired and then scans the machine-readable codes of the items to be compared. In other instances, the user may access a display of a history of scanned barcodes and select the items to be compared. The display of the history of scanned barcodes may include images of the barcodes, the alphanumeric characters decoded from the machine-readable code, or a short description (e.g., title) of the item. From the display of the history, the user may select the barcodes to be compared.

The item comparison interface includes information about the items being compared in a format that allows the user to compare the attributes of the items. For example, the item comparison interface may include an image of each item and a list of shared attributes of the items. The item comparison interface may display values corresponding to each attribute for the respective items. In some instances, the item comparison interface may include ratings or recommendations for the respective items being compared.

A user profile module 206 is configured to access and maintain a user profile record that includes information about the user. The user profile module 206 may have further access to a history recorded about the user's past activities, such as items previously purchased by the user. The user profile module 206 may filter the history of the user according to seller to generate a history of the user with a particular seller.

An advertisement module 208 is configured to identify one or more advertisements to display to the user. The advertisement module 208 may have access to a plurality of available advertisements stored in a coupled database that may be shown to the user from which a portion is ultimately displayed to the user. The advertisements may be identified based on the machine-readable codes scanned by the user or based on information stored in the user profile.

In some instances, the advertisement module 208 may conduct a sale of ad space so that when a barcode is scanned, an advertisement is provided to the client machine according to the advertiser who purchased ad space corresponding to a scanned machine-readable code. The ad space may be provided to the advertisers by grouping available barcodes into batches of one or more related barcodes. A description of the respective batches of machine-readable codes may be provided to potential advertisers. The advertisers may, in turn, offer to purchase ad space associated with each machine-readable code according to a sale format. The sale format may be, for example, fixed price or an auction format where the ad space is sold to the highest bidder. In some instances, the advertisers may specify the ad to be displayed, a size of the ad to be displayed, whether the ad includes any multimedia content, a time period during which the ad is to be displayed, or the like. Further, the advertisers may purchase ad space based on the characteristics of the users who are provided the ad. To illustrate, the advertiser may specify that the ad be shown to males ages 15-24 who have previously purchased a gaming console or gaming console accessories.

Based on the advertiser who has purchased ad space corresponding to a machine-readable code scanned by the user of the client machine, the advertisement module 208 provides an advertisement to the user. The advertisement may be an advertisement for the item corresponding to the scanned machine-readable code or for another item. The advertisement may include one or more incentives (e.g., coupons) redeemable using the client machine.

A social integration module 210 is configured to access information about items provided by people identified by the user as being connected to the user via a social network. The user may belong to a number of social networks and have identified a number of people as friends, contacts, colleagues, family members, or other interpersonal relationship. The social integration module 210 is configured to, upon receipt of a scanned machine-readable code, identify information about the item described by the scanned machine-readable code such as ratings, recommendations, suggested accessories, available incentives, or the like that is provided by the connected people in the social network.

The incentive generation module 212 is configured to generate one or more incentives tailored to the user who scanned the machine-readable code. The incentives may be a discount (including discounts based on a quantity of items purchased), a discount on related items (e.g., accessories), a loyalty reward, an upgrade, a rebate, or the like. The incentives may be tailored based on the items being compared by the comparison module 204, the information about the user accessed by the user profile module 206, or information accessed via the social integration module 210.

The incentive generation module 212 may provide an indication to a third party system, such as a merchant system, a retailer system, a manufacturer system, or a distributor system, that the user has scanned particular machine-readable codes. In response, the third party system, using information accessed by the user profile module 206 or the other system, may tailor an incentive to the user.

To illustrate, a user may identify two comparable items on a store shelf that would separately fulfill a shopping goal of the user. The user may, using the code identification module 202, scan a machine-readable code corresponding to each item. The comparison module 204 may provide a GUI used to compare the two items. A second GUI may include ratings and recommendations accessed by the social integration module 210. Based on the above information, it may be apparent that a first item is more desirable than the second item but is more expensive. The merchant may, upon receiving a communication that the customer has scanned the two items, access the information maintained by the user profile module 206 to determine that the user is a valued and repeat customer. The merchant may, using the incentive generation module 212, provide the user with an incentive to purchase the second item.

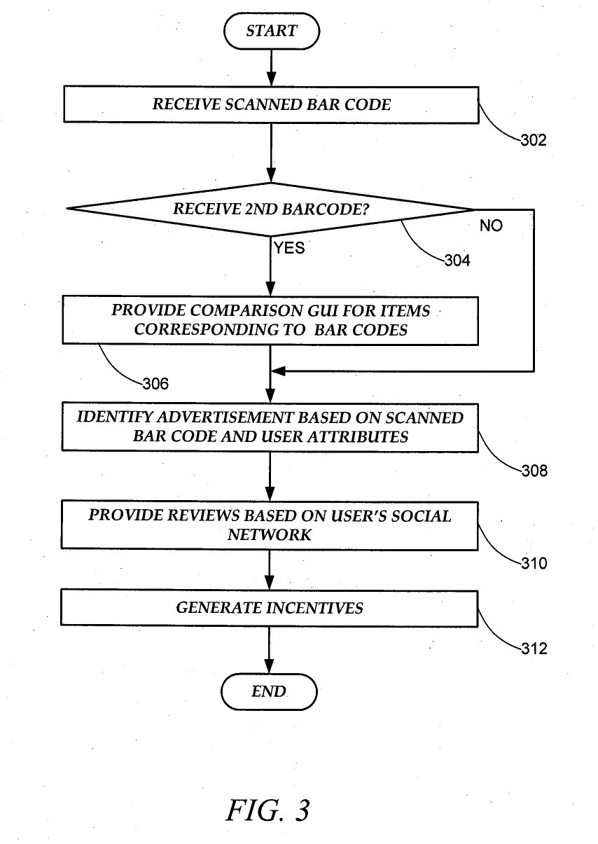

FIG. 3 is a flowchart illustrating an example method 300 of providing incentives, according to various embodiments. The method 300 may be at least partially performed by the information system 200. It is noted that the method 300 may be only partially performed in a given instance by, for example, skipping certain operations or by performing some operations more than once. The sequence of steps shown in FIG. 3 is merely for illustrative purposes and is not intended to be limiting.

In an operation 302, a scanned, machine-readable code is received. In some instances, the scanned machine-readable code comprises an image of the machine-readable code captured by a digital camera of a client device (e.g., smartphone). The machine-readable code may be read to identify a series of alphanumeric characters. The series of alphanumeric characters, in turn, corresponds to a description of an item. The description of the item may be provided to the client machine used by the user.

In an operation 304, a determination is made as to whether a second (or further) machine-readable code has been scanned by the user. If no further machine-readable code has been scanned, the method 300 proceeds to operation 308. If a further machine-readable code has been scanned, a comparison GUI is generated for the scanned items in an operation 306. The comparison GUI may be generated automatically or may be generated in response to a request for the comparison GUI.

In an operation 308, one or more advertisements are identified based on the scanned machine-readable code and attributes about the user. The advertisements may appear as a GUI or a portion of a GUI, such as a comparison GUI for comparing two or more items.

In an operation 310, reviews and ratings of the items corresponding to the scanned machine-readable codes are provided to the client device. The reviews and ratings may be based on the interpersonal connections of the user accessible via a social, network.

In an operation 312, incentives are generated for the user. The incentives may be generated based on information about the user.

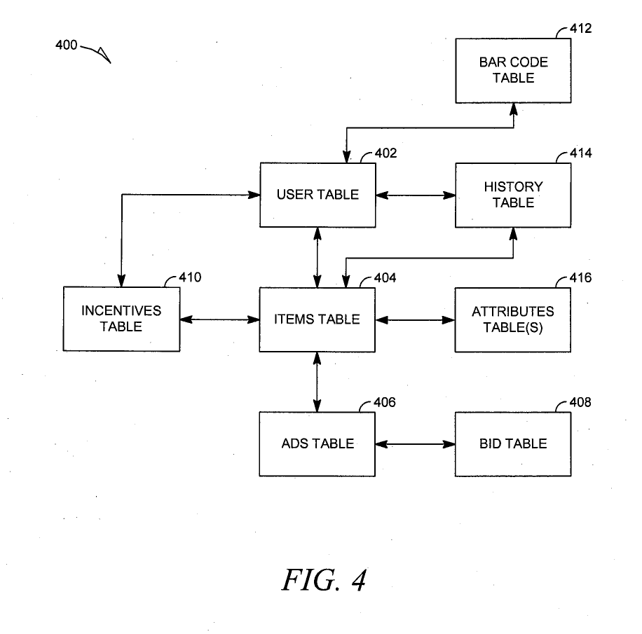

FIG. 4 is a high-level entity-relationship diagram, illustrating various tables that may be maintained within the databases 126, and that are utilized by and support the example information system. A user table 402 contains a record for each registered user of the networked system 102, and may include identifier, address and financial instrument information pertaining to each such registered user. The user table 402 may further include demographic information about the user.

The tables 400 also include an items table 404 in which are maintained item records for goods and services that are available to be, or have been, transacted via the networked system 102. Each item record within the items table 404 may furthermore be linked to one or more user records within the user table 402, so as to associate one or more actual or potential buyers with each item record.

An ads table 406 contains a record for each advertisement displayed when a machine-readable code is scanned that pertains to items for which records exist within the items table 404.

A bid table 408 is populated with bid records, each bid record being associated with an advertisement, ad space, and other information about the ad. Each bid, in turn, may be with respect to one or more advertisements for which records exist within the ads table 406.

Incentive records within an incentives table 410 each relate to an incentive received at the networked system 102 in connection with scanned machine-readable code. A machine-readable code table 412 is utilized by the code identification module 202, in one example embodiment, to construct and maintain descriptions of items corresponding to the machine-readable codes. A history table 414 maintains a history of transactions to which a user has been a party. One or more attributes tables 416 record attribute information pertaining to items for which records exist within the items table 404. Considering only a single example of such an attribute, the attributes tables 416 may indicate a price attribute associated with a particular item, the price attribute identifying the price for the relevant item as specified in by a seller.

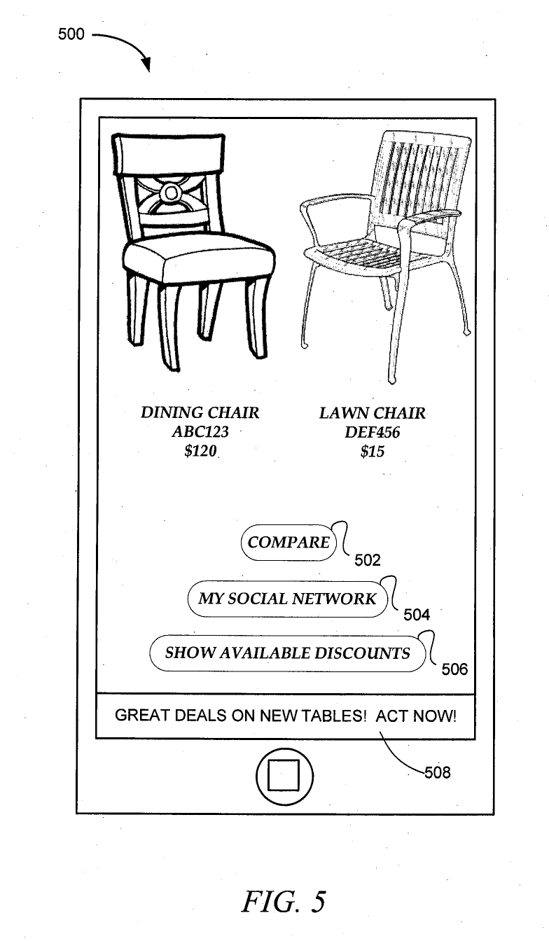

FIGS. 5-8 depict example user interfaces that may be presented to the user, according to an example embodiment. The interfaces provided are not intended to be limiting and are provided merely for illustration. FIGS. 5-8 depict interfaces showing two items side-by-side. It is understood that these interfaces may be generated for one item or for three or more items, up to limits dictated by the amount of the display space of the client machine.

FIG. 5 depicts an interface 500 generated in response to machine-readable codes having been scanned by a user of a client device and provided to a client machine for display. The interface 500 includes a description of the items for which machine-readable codes were scanned. The description may include, as depicted, an image of the items corresponding to the scanned machine-readable code, a name of the item, a series of alphanumeric characters encoded by the scanned machine-readable code, and a price of the item. Other information may also be included.

A button 502, labelled “compare”, is provided in the interface 500. Upon receiving a selection of this button 502, a comparison GUI may be provided to the client machine for display to the user by the comparison module 204. A second button 504, labelled “my social networks”, allows a user of the client machine to request that ratings and reviews be accessed that were previously received from people connected to the user via a social network. Activation of the second button 504 causes the social integration module 210 to obtain the ratings and reviews. A third button 506, labelled “show available discounts”, may be selected by the user to request discounts associated with each item. Activation of the third button 506 causes the incentive generation module 212 to determine one or more incentives to provided to the user. In some instances, the buttons 502-506 may be provided separately for each item shown in the interface 500. In those instances, the following interfaces may be provided for one item instead of two items.

At a bottom portion of the interface 500, an advertisement 508 is displayed. The advertisement 508 may be selectable to allow the user to navigate to another interface having additional information about items described in the advertisement 508. The advertisement 508 may be selected from a plurality of advertisements based on the machine-readable codes scanned, the user profile, and bids for the ad space on the interface 500 when a particular machine-readable code is scanned by the advertisement module 208.

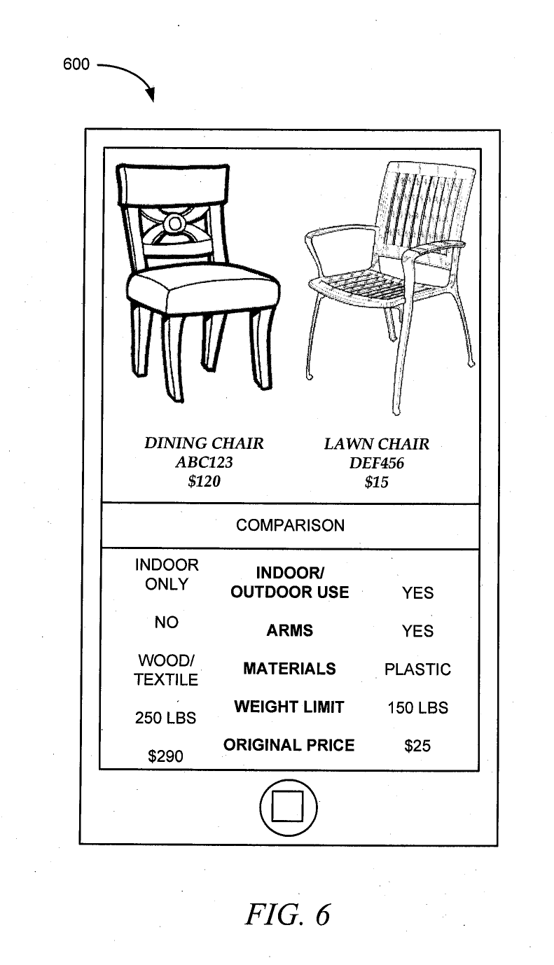

FIG. 6 depicts an example of a comparison interface 600 that may be provided to the client machine upon receipt of a selection of the button 502, labelled “compare”. The comparison interface 600 may include a table that is generated using attribute-value pairs associated with each scanned code of an item. The attributes may vary depending on the code scanned. A center column of the table lists the attributes being compared. The left and right columns, respectively, provide the values corresponding to each attribute for each item being compared.

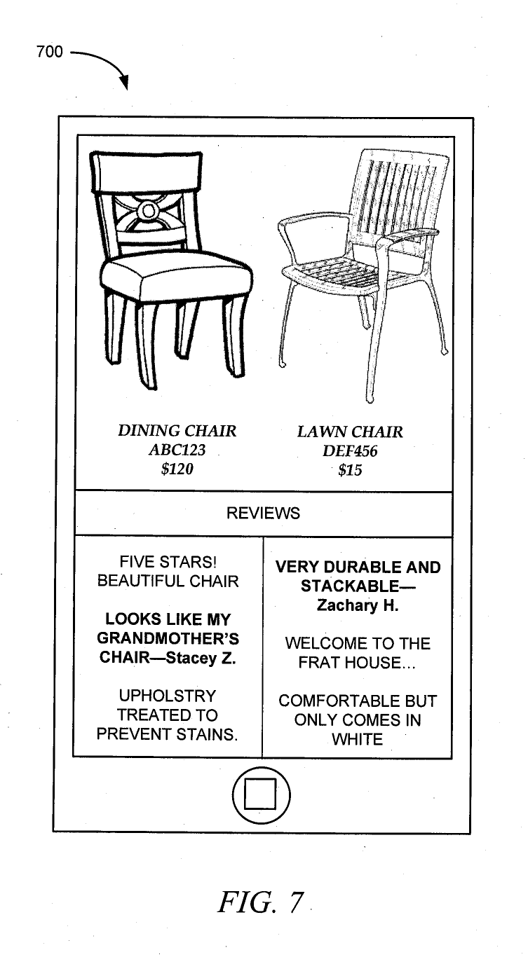

FIG. 7 depicts an example of a ratings and reviews interface 700 that may be provided to the client machine upon receipt of a selection of the button 504, labelled “my social networks” while in the comparison mode. The interface 700 depicts a description of the scanned items and a table that provides ratings and reviews of the items. The ratings and reviews may include publicly available reviews and reviews provided by people connected to the user via a social network. As depicted, reviews provided by people in the user's social network are depicted in bold lettering and indicate the identity of the reviewer.

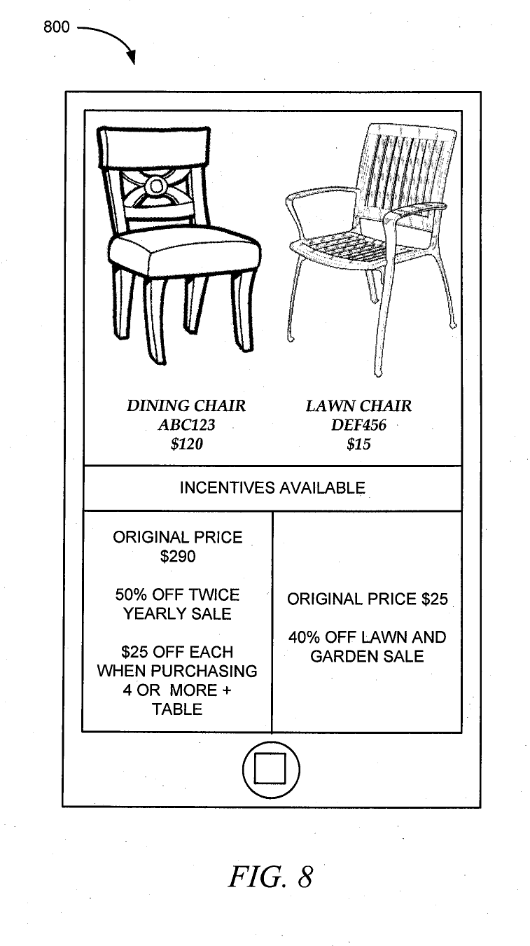

FIG. 8 depicts an example of an incentives interface 800 that may be provided to the client machine upon receipt of a selection of the button 506, labelled “show available discounts”. The interface 800 depicts a description of the scanned items and a table that provides an original price of each item and one or more discounts that apply if the user purchases the respective items. The incentives may be tailored to the user based on user profile information or a user purchase history. The incentives may be offered by the store or by another entity.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

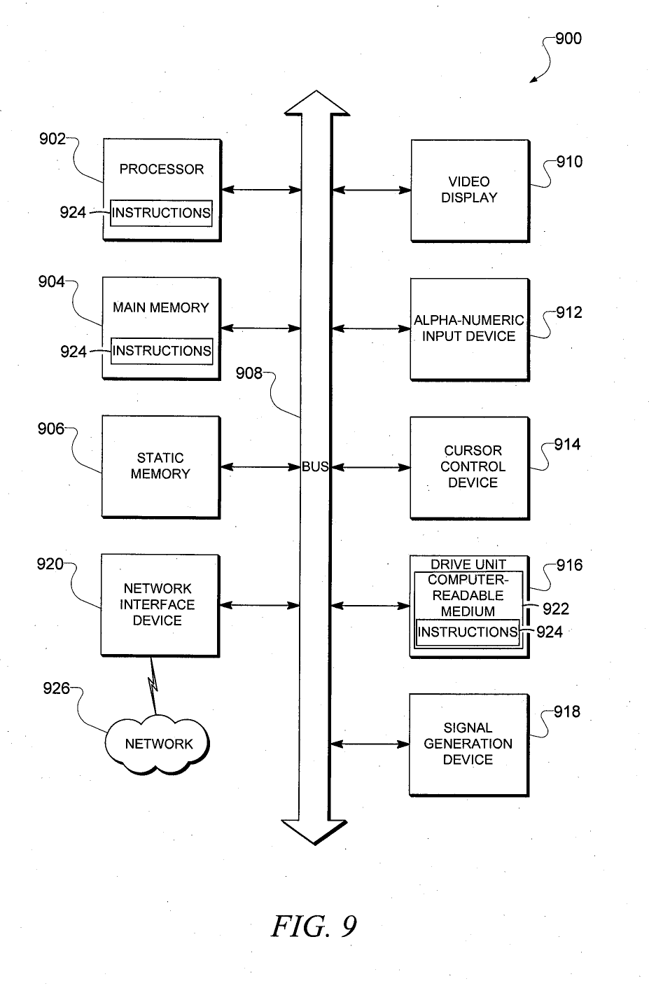

FIG. 9 is a block diagram of machine in the example form of a computer system 900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a code identification module to receive one or more scanned machine-readable codes and to identify respective descriptions of the items corresponding to the one or more scanned machine-readable codes; and
an incentive generation module to provide to a user an incentive interface depicting a first description of a first set of incentives available with a purchase of a first item corresponding to a first scanned machine-readable code of the one or more scanned machine-readable codes and second description of a second set of incentives available with the purchase of a second item corresponding to a second scanned machine-readable code of the one or more scanned machine-readable codes.

2. The system of claim 1, wherein the code-identification module is further to receive a selection of the first machine-readable code for inclusion in the incentive interface, the first machine-readable code being previously stored by the code identification module.

3. The system of claim 1, further comprising a comparison module to provide a comparison interface to a client machine, the comparison interface comprising a table generated based on attribute-value pairs corresponding to the first item and the second item.

4. The system of claim 1, further comprising an advertisement module to identify an advertisement opportunity, the advertisement opportunity comprising an area of the incentive interface and based on at least the first machine-readable code being scanned, select an advertisement from a plurality of available advertisements.

5. The system of claim 4, wherein the advertisement module is further to select the advertisement based on a purchase history of the user.

6. The system of claim 4, wherein the advertisement module is further to select the advertisement based on profile information about the user.

7. The system of claim 1, further comprising a user profile module configured to record user profile information and purchase history of the user.

8. The system of claim 1, further comprising a social integration module to generate a reviews and ratings interface, the reviews and ratings interface comprising a display of one or more reviews of the first item from other users who are connected to the user via a social network.

9. The system of claim 8, wherein the ratings and reviews interface includes a display of one or more publicly available reviews.

10. The system of claim 8, wherein the social integration module is further to provide an incentive to the user that was stored by one of the other users.

11. The system of claim 1, wherein the first set of incentives comprises at least one incentive that is not included in the second set of incentives.

12. The system of claim 1, wherein the first set of incentives includes at least one of a price discount, a quantity discount, a discount based on the purchase of a third item, or a loyalty reward.

13. The system of claim 1, wherein the first set of incentives includes an incentive received by the user from another user.

14. The system of claim 1, wherein the first set of incentives includes an incentive available to the user based on the second scanned machine-readable code.

15. The system of claim 1, wherein the first set of incentives is generated based on a purchase history of the user.

16. The system of claim 1, wherein the first set of incentives is generated based on profile information about the user.

17. The system of claim 1, wherein the incentive interface includes an indication of an original price and a discounted price of the first item.

18. The system of claim 1, wherein the first set of incentives includes an incentive generated based on information associated with other users who are connected to the user via a social network.

19. A method comprising:
receiving one or more scanned machine-readable codes and to identify respective descriptions of the items corresponding to the one or more scanned machine-readable codes; and
providing to a user an incentive interface depicting a first description of a first set of incentives available with a purchase of a first item corresponding to a first scanned machine-readable code of the one or more scanned machine-readable codes and second description of a second set of incentives available with the purchase of a second item corresponding to a second scanned machine-readable code of the one or more scanned machine-readable codes.

20. A non-transitory machine-readable having instructions embodied thereon, the instructions executable by one or more machines to perform operations comprising:
receiving one or more scanned machine-readable codes and to identify respective descriptions of the items corresponding to the one or more scanned machine-readable codes; and
providing to a user an incentive interface depicting a first description of a first set of incentives available with a purchase of a first item corresponding to a first scanned machine-readable code of the one or more scanned machine-readable codes and second description of a second set of incentives available with the purchase of a second item corresponding to a second scanned machine-readable code of the one or more scanned machine-readable codes.
